(19) United States
(12) Patent Application Publication
(10) Pub. No.: US 2024/0384596 A1
(43) Pub. Date: Nov. 21, 2024

(54) Ladder Stabilizer

(71) Applicants: Brian M. Sweig, Carmel, NY (US); Richard Sweig, Somers, NY (US)

(72) Inventors: Brian M. Sweig, Carmel, NY (US); Richard Sweig, Somers, NY (US)

(21) Appl. No.: 18/198,347

(22) Filed: May 17, 2023

(51) Int. Cl. E06C 7/48

(52) U.S. Cl. CPC E06C 7/484

(57) ABSTRACT

A ladder with a distally attached curved metal support with two triangular supports which are covered with a high friction coefficient surface such as rubber. These triangular supports allow for greater surface area contact on angled roofs so that the supports won't damage non-asphalt roofs. The triangular supports also allow additional stability to prevent the ladder from sliding off the side of a roof.

### BACKGROUND OF THE INVENTION

While there are different ladder stabilizers, the roofing and construction industry do not have ladder stabilizers that safeguard against slate, tile, or other types of roofing material. Nor do they create a slip free factor, however, the present subject matter overcomes these issues.

Other ladder stabilizers can also damage non-asphalt roofs because the point of contact does not cover enough surface area.

### SUMMARY OF THE INVENTION

The present subject matter comprises of a ladder with a distally attached curved metal support with two triangular supports which are covered with a high friction coefficient surface such as rubber.

The triangular supports allow for greater surface area contact on angled roofs so that the supports won't damage non-asphalt roofs. The triangular supports also allow additional stability to prevent the ladder from sliding off the side of a roof.

In some embodiments, the triangular supports are pivotably affixed to the distally attached curved metal support to allow for a range of rotation to enable greater contact with roofs of different pitches. This additional contact allows for greater stability by increasing the amount of friction between the roof's surface and the ladder itself.

### DESCRIPTION OF DRAWINGS

FIG. 1 shows a front view of the ladder stabilizer in use against a roof.

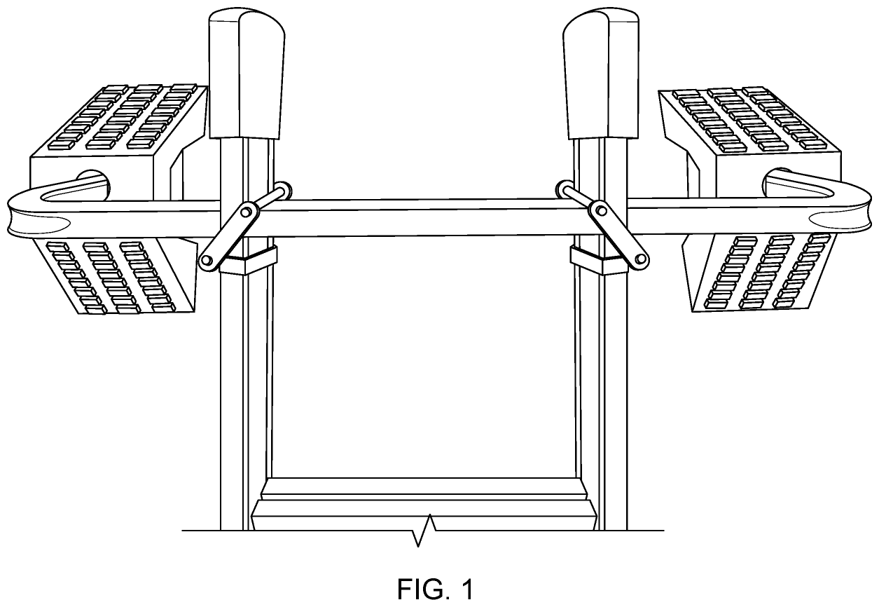

FIG. 2 shows a front perspective view of the ladder stabilizer in use against a roof.

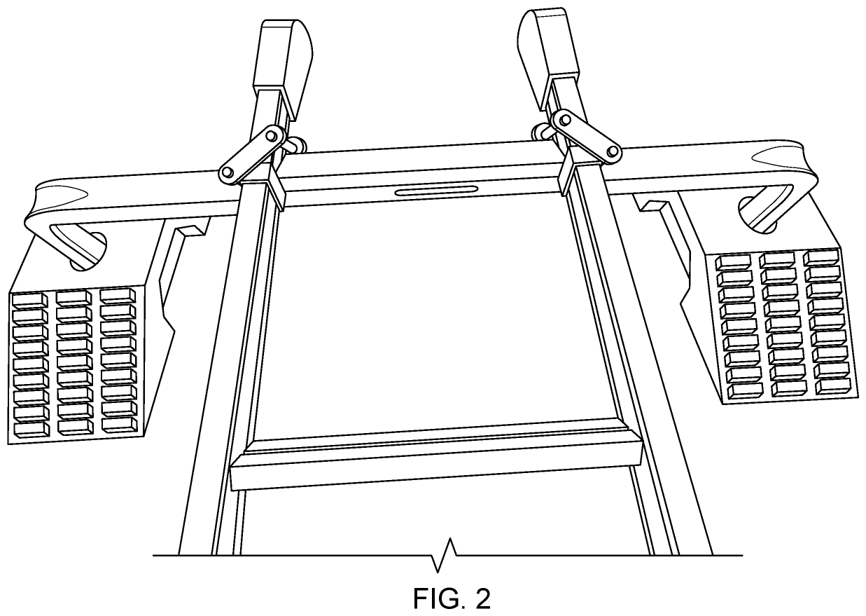

FIG. 3 shows an underneath perspective view of the ladder stabilizer against the ground.

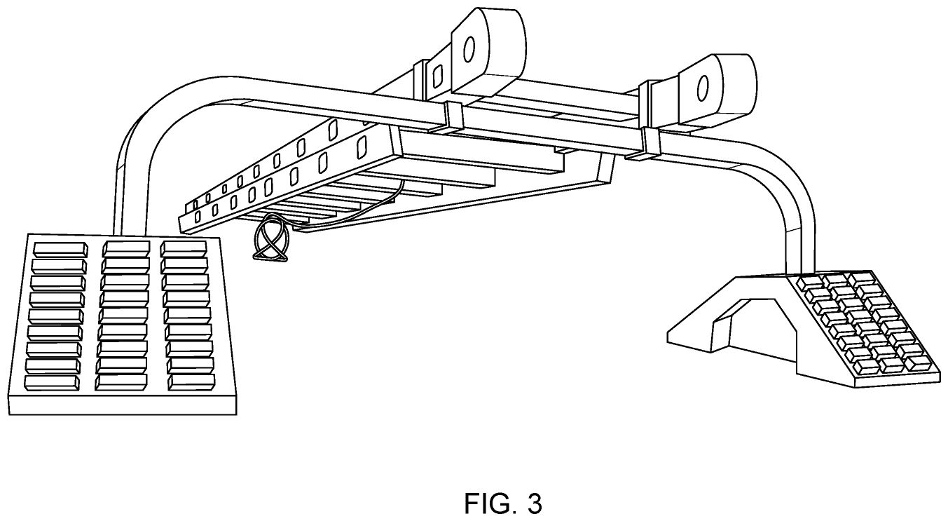

FIG. 4 shows a top perspective view of the ladder stabilizer against the ground.

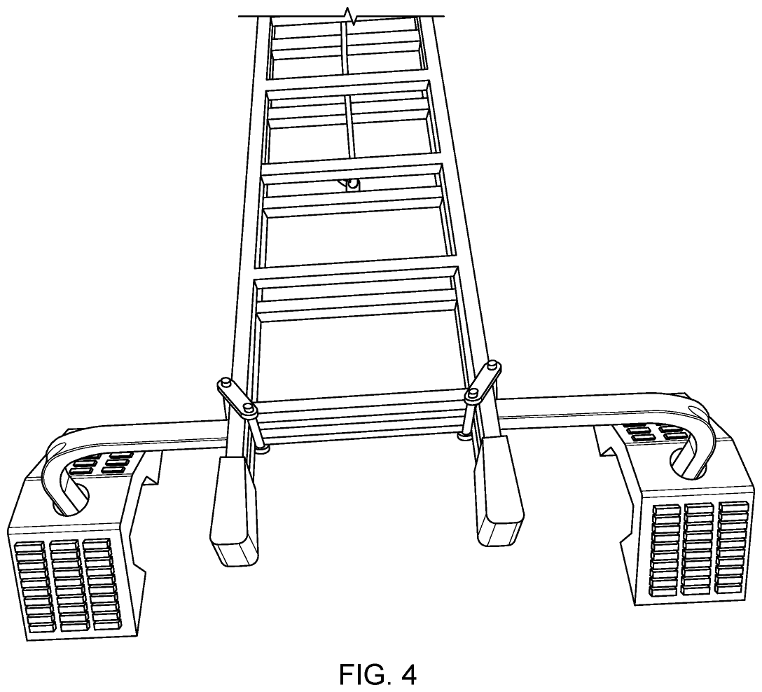

FIG. 5 shows a side perspective view of the ladder stabilizer making contact with a roof.

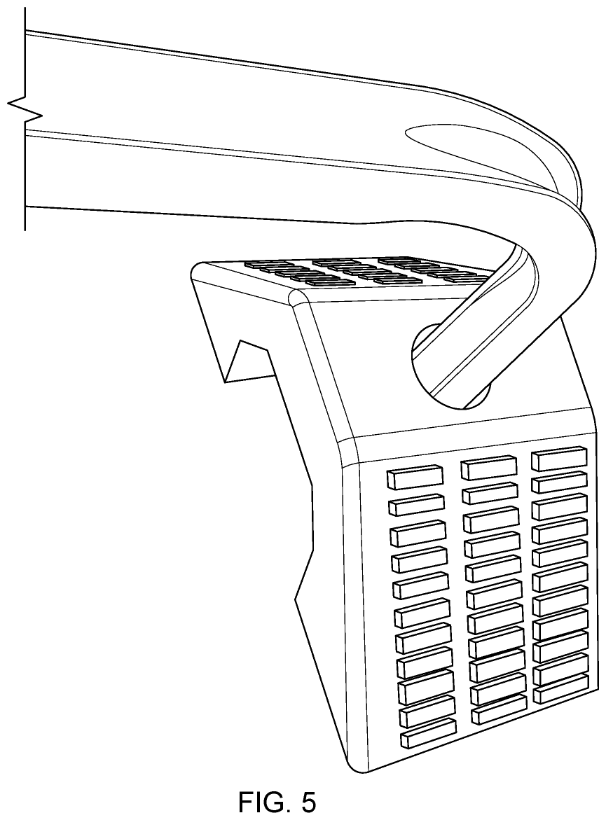

FIG. 6 shows a front view of the ladder stabilizer in use against a roof.

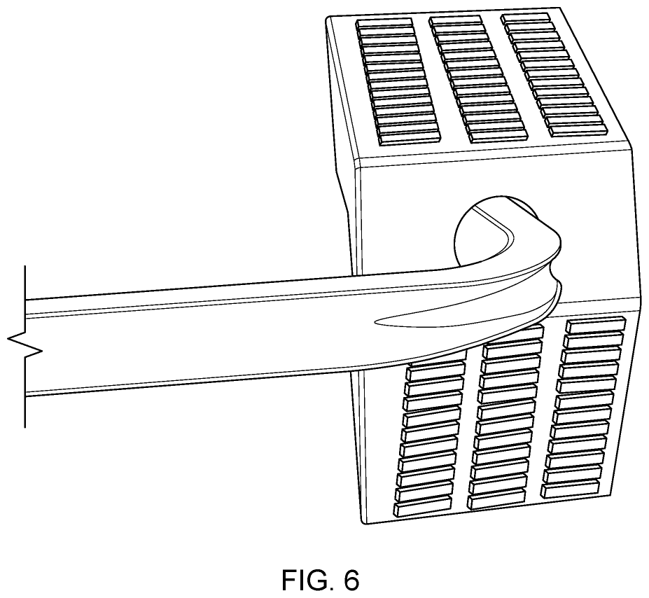

### DESCRIPTION OF THE INVENTION

The present subject matter comprises of a ladder with a distally attached curved metal support with two triangular supports which are covered with a high friction coefficient surface such as rubber.

The present subject matter also contemplates other high friction coefficient materials such as silicone or a layer of asphalt.

The triangular supports allow for greater surface area contact on angled roofs so that the supports won't damage non-asphalt roofs. The triangular supports also allow additional stability to prevent the ladder from sliding off the side of a roof.

The triangular supports have a minimum width of 6-8 inches to help increase the total amount of surface area contact with the roof and increase stability.

In some embodiments, the triangular supports are pivotably affixed to the distally attached curved metal support to allow for a range of rotation to enable greater contact with roofs of different pitches. This additional contact allows for greater stability by increasing the amount of friction between the roof's surface and the ladder itself.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. A ladder stabilizer comprising of a ladder, a distally attached curved metal support, two triangular supports, and a high friction coefficient surface.

2. The ladder stabilizer comprising of the ladder, the distally attached curved metal support, two triangular supports, and the high friction coefficient surface as in claim 1, wherein the high friction coefficient surface is affixed to the triangular supports.

3. The ladder stabilizer comprising of the ladder, the distally attached curved metal support, two triangular supports, and the high friction coefficient surface as in claim 1, wherein the high friction coefficient surface comprises of rubber, silicone, or other substance.

4. The ladder stabilizer comprising of the ladder, the distally attached curved metal support, two triangular supports, and the high friction coefficient surface as in claim 1, wherein the triangular supports are pivotally attached to the curved metal support.

5. The ladder stabilizer comprising of the ladder, the distally attached curved metal support, two triangular supports, and the high friction coefficient surface as in claim 1, wherein the triangular supports are 6 to 8 inches in width.

6. A method of manufacturing a ladder stabilizer comprising of a ladder, a distally attached curved metal support, two triangular supports, and a high friction coefficient surface.

7. The method of manufacturing the ladder stabilizer comprising of the ladder, distally attached curved metal support, two triangular supports, and high friction coefficient surface as in claim 6, wherein the high friction coefficient surface is affixed to the triangular supports.

8. The method of manufacturing the ladder stabilizer comprising of the ladder, distally attached curved metal support, two triangular supports, and high friction coefficient surface as in claim 6, wherein the high friction coefficient surface comprises of rubber, silicone, or other substance.

9. The method of manufacturing the ladder stabilizer comprising of the ladder, distally attached curved metal support, two triangular supports, and high friction coefficient surface as in claim 6, wherein the triangular supports are pivotally attached to the curved metal support.

10. The method of manufacturing the ladder stabilizer comprising of the ladder, distally attached curved metal support, two triangular supports, and high friction coefficient surface as in claim 6, wherein the triangular supports are 6 to 8 inches in width.

11. A method of using a ladder stabilizer comprising of a ladder, a distally attached curved metal support, two triangular supports, and a high friction coefficient surface.

12. The method of using the ladder stabilizer comprising of the ladder, distally attached curved metal support, two triangular supports, and high friction coefficient surface as in claim 10, wherein the high friction coefficient surface is affixed to the triangular supports.

13. The method of using the ladder stabilizer comprising of the ladder, distally attached curved metal support, two triangular supports, and high friction coefficient surface as in claim 10, wherein the high friction coefficient surface comprises of rubber, silicone, or other substance.

14. The method of using the ladder stabilizer comprising of the ladder, distally attached curved metal support, two triangular supports, and high friction coefficient surface as in claim 10, wherein the triangular supports are pivotally attached to the curved metal support.

15. The method of using the ladder stabilizer comprising of the ladder, distally attached curved metal support, two triangular supports, and high friction coefficient surface as in claim 10, wherein the triangular supports are 6 to 8 inches in width.
